(19) United States
(12) Patent Application Publication
(10) Pub. No.: US 2026/0119865 A1
(43) Pub. Date: Apr. 30, 2026

(54) SYSTEMS AND METHODS FOR ELIGIBILITY ENGINES USING GENERATIVE ARTIFICIAL INTELLIGENCE MODELS

(71) Applicant: Palantir Technologies Inc., Denver, CO (US)

(72) Inventors: Mark Bissell, New York, NY (US); Jeremy David, Brooklyn, NY (US); Mehdi Berrada Mnimene, Brooklyn, NY (US)

(21) Appl. No.: 19/043,196

(22) Filed: Jan. 31, 2025

Related U.S. Application Data
(60) Provisional application No. 63/712,863, filed on Oct. 28, 2024.

(51) Int. Cl. G06N 3/08; G06N 3/0475

(52) U.S. Cl. CPC G06N 3/08; G06N 3/0475

(57) ABSTRACT

In some examples, systems and methods for eligibility evaluation are provided. For example, a method includes: receiving an input associated with an eligibility type that is used to determine whether one or more criteria are satisfied; generating a first criterion object type based at least in part on the input and being associated with at least one of the one or more criteria, the first criterion object type being one of a plurality of criterion object types associated with the eligibility type object type, the first criterion object type including a first criterion field for an indication of a criterion evaluation modality and a second criterion field for an indication of an instruction; and linking the first criterion object type to an eligibility type object type representing the eligibility type, the eligibility type object type associating with a plurality of criterion object types including the first criterion object type.

### CROSS REFERENCE TO RELATED APPLICATIONS

This application claims priority to U.S. Provisional Application No. 63/712,863, filed Oct. 28, 2024, incorporated by reference herein for all purposes.

### FIELD

Certain embodiments of the present disclosure relate to eligibility engines (e.g., engines for evaluating eligibility including evaluating one or more criteria). More particularly, some embodiments of the present disclosure relate to eligibility engines using generative artificial intelligence (AI).

### BACKGROUND

Many organizations evaluate eligibility (e.g., medical treatments eligibility, insurance eligibility, etc.) every day. In some embodiments, documents, policies, and other information are used to determine eligibility.

Hence, it is desirable to improve techniques for determining eligibility.

### SUMMARY

Certain embodiments of the present disclosure relate to eligibility evaluation (e.g., document writing). More particularly, some embodiments of the present disclosure relate to eligibility evaluation using generative artificial intelligence (AI).

At least some embodiments are directed to a method for eligibility evaluation. In certain embodiments, the method includes: receiving an input associated with an eligibility type that is used to determine whether one or more criteria are satisfied; generating a first criterion object type based at least in part on the input and being associated with at least one of the one or more criteria, the first criterion object type being one of a plurality of criterion object types associated with the eligibility type object type, the first criterion object type including a first criterion field for an indication of a criterion evaluation modality and a second criterion field for an indication of an instruction, the criterion evaluation modality including at least one selected from a group consisting of a generative artificial intelligence (GenAI) evaluation modality and a function evaluation modality; and linking the first criterion object type to an eligibility type object type representing the eligibility type, the eligibility type object type associating with a plurality of criterion object types including the first criterion object type; wherein the method is performed by one or more processors.

At least some embodiments are directed to a method for eligibility evaluation, the method comprising: receiving an evaluation trigger associated with an entity; accessing an eligibility-type object type, the eligibility-type object type associating with a plurality of criterion object types, a first criterion object type of the plurality of criterion object types including a first criterion field for an indication of a criterion evaluation modality and a second criterion field for an indication of an instruction; generating an eligibility evaluation object in response to receiving the evaluation trigger by instantiating the eligibility-type object type; instantiating the first criterion object type to generate a first criterion evaluation object, the indication of the criterion evaluation modality in the first criterion field of the first criterion evaluation object indicating a GenAI evaluation modality, the first criterion evaluation object having a link to the eligibility evaluation object; receiving an input associated with a prompt structure in the instruction in the first criterion field of the first criterion evaluation object; constructing a query prompt using the prompt structure based at least in part on the input; providing the constructed query prompt to the GenAI model; receiving a first evaluation result from the GenAI model; and determining an eligibility result of the entity based at least in part on the first evaluation result; wherein at least a part of the method is performed by one or more processors.

At least some embodiments are directed to a system for eligibility evaluation, the system comprising: one or more memories comprising instructions stored thereon; and one or more processors configured to execute the instructions and perform operations comprising: receiving an evaluation trigger associated with an entity; accessing an eligibility-type object type, the eligibility-type object type associating with a plurality of criterion object types, a first criterion object type of the plurality of criterion object types including a first criterion field for an indication of a criterion evaluation modality and a second criterion field for an indication of an instruction; generating an eligibility evaluation object in response to receiving the evaluation trigger by instantiating the eligibility-type object type; instantiating the first criterion object type to generate a first criterion evaluation object, the indication of the criterion evaluation modality in the first criterion field of the first criterion evaluation object indicating a GenAI evaluation modality, the first criterion evaluation object having a link to the eligibility evaluation object; receiving an input associated with a prompt structure in the instruction in the first criterion field of the first criterion evaluation object; constructing a query prompt using the prompt structure based at least in part on the input; providing the constructed query prompt to the GenAI model; receiving a first evaluation result from the GenAI model; and determining an eligibility result of the entity based at least in part on the first evaluation result.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified diagram showing a software architecture and/or workflow for eligibility evaluation according to certain embodiments of the present disclosure.

FIG. 2 is an example of object types according to certain embodiments of the present disclosure.

FIG. 3 is an example of evaluation objects according to certain embodiments of the present disclosure.

FIG. 4 is a simplified diagram showing a method for eligibility evaluation according to certain embodiments of the present disclosure.

FIG. 5 is a simplified diagram showing a method for eligibility evaluation according to certain embodiments of the present disclosure.

FIG. 6 is an illustrative eligibility evaluation environment according to certain embodiments of the present disclosure.

FIG. 7 is an example user interface of generating and/or updating a criterion according to certain embodiments of the present disclosure.

FIG. 8 is an example user interface of eligibility evaluation according to certain embodiments of the present disclosure.

FIG. 9 is a simplified diagram showing a computing system for implementing a system for eligibility evaluation in accordance with at least one example set forth in the disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any number within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods often cannot assess eligibility efficiently. In some examples, conventional systems and methods take time to determine eligibility manually or semi-manually. For example, in order to discharge to a long-term acute care facility, a first patient must meet seven criteria, and to discharge a second patient from a hospital's discharge lounge, the second patient must meet five criteria. Conventional systems and methods often lack a way to handle the various eligibility requirements efficiently.

Various embodiments of the present disclosure can achieve benefits and/or improvements by using an eligibility evaluation system (e.g., a software module, a software piece, etc.), also referred to as eligibility engine, for assessing a set of criteria corresponding to an eligibility of an entity (e.g., a person, an organization, etc.). In some embodiments, the eligibility evaluation system solves the problem of identifying eligible entities (e.g., patients, persons, organizations, things, etc.) from a group of entities (e.g., a population) by using a combination of deterministic code (e.g., functions etc.) and AI-based (e.g., artificial intelligence (AI) model, generative AI (GenAI) model, language model (LM), large language model (LLM), etc.) machine reasoning to assess a set of criteria against each candidate entity. In some embodiments, the disclosure is relevant in any context in which there is a set of criteria (e.g., a known and fixed set of criteria, a set of criteria that is dynamic and subject to changes, a set of criteria including criteria to be extracted from an external source, etc.) that are used to determine eligibility, and it is required to determine whether specific people or things meet some combination of these criteria (e.g., meet at least one of the criteria, meet all criteria, meet a part of the criteria, meet every inclusion criteria and does not meet all exclusion criteria, and/or the like, etc.), referred to as eligibility evaluation. In certain embodiments, a generative AI model is a subset of artificial intelligence models that can produce text, images, audios, videos, and/or other forms of data.

According to some embodiments, the eligibility engine (e.g., the eligibility evaluation system) solves the problem of eligibility evaluation by (1) allowing users to create, store, evaluate, and iterate on the structure of configurable eligibility-types (e.g., eligibility-type object types, things an entity can be eligible for, etc.) and criterion objects that are used to assess an entity based on user-defined properties such as code, parameters, or natural language instructions to guide a GenAI model (e.g., an LLM), and/or (2) offering a framework for these eligibility-types to be automatically assessed based on time-based and/or event-based triggers with the resulting recommendations provided to users for human review and/or action.

In certain embodiments, an ontology refers to a structural framework (e.g., object models) containing information and data related to objects and relationships of objects (e.g., functions applicable to objects, links) within a specific domain (e.g., an organization, an industry). In some embodiments, an action refers to one or more processing logics applied to one or more objects including, for example, creating objects, changing objects, combining objects, linking objects, deleting objects, and/or the like. In certain embodiments, ontologies include object types, action types, and link types, collectively referred to as object types. In some embodiments, an object type is a software structure (e.g., metadata, an object structure, etc.) that can be instantiated as one or more objects of the object type. In certain embodiments, the object type includes one or more data structures (e.g., data fields, object fields, etc.) for one or more object properties. For example, an eligibility-type object type is an object type for patient discharge, a first eligibility evaluation object is an instantiation of the eligibility-type object type for patient discharge for a patient, and a second eligibility evaluation object is an instantiation of the eligibility-type object type for patient discharge for a second patient.

According to certain embodiments, the eligibility engine can provide eligibility assessment based on criteria related to deterministic evaluations of structured data (e.g., evaluate whether a value associated with a parameter exceed a threshold, etc.), criteria related to simple evaluations of unstructured data (e.g., evaluate whether a note mention that a patient has a certain condition, etc.), criteria related to complex evaluations of unstructured data (e.g. evaluate whether a patient's medical records suggest that they are experiencing altered mental status as defined by a user-configurable definition of AMS (altered mental status), and/or the like, and/or combinations of the foregoing. In some examples, the eligibility engine can assess patient eligibility for programs, services, and other eligibility-types that are relevant within a hospital setting. In some embodiments, the eligibility engine can only access patient data/records that it has been granted access to (e.g. following a formal review process for determining whether personal data can be made available to the eligibility engine). In certain embodiments, the eligibility engine can assess eligibility of entities (e.g., assessing external facility eligibility based on predefined criteria, assessing whether clinical notes meet criteria for acceptable level of detail, etc.), and/or for assessing entities in other contexts.

According to some embodiments, the eligibility engine makes recommendations as to which entities from a population are eligible for a particular thing (e.g., an eligibility-type) using a combination of deterministic code and GenAI-based machine reasoning to assess a set of criteria against each candidate entity. When creating a new eligibility-type, in certain embodiments, the eligibility engine allows users to create new criterion object types or re-use existing criterion object types from a stored criteria bank that including a plurality of criterion object types (e.g., a plurality of criterion object types, etc.). In some embodiments, each criterion contains information about how it ought to be evaluated, including a flag for its general evaluation modality (e.g., deterministic code versus LLM processing, a function evaluation modality, a GenAI evaluation modality, etc.).

If the criterion object type is to be evaluated via a function (e.g., a set of software code implementing the function, deterministic code, etc.), in certain embodiments, the eligibility engine can store details such as the name of the function used for evaluation and parameters (e.g., any necessary parameters, etc.). If the criterion object type is to be evaluated using an LLM, in some embodiments, the eligibility engine can store metadata such as the recommended model to use and the specific instructions (e.g., prompt, prompt structure, etc.) that should be used to generate (e.g., injected into) the prompt (e.g., prompt generated by the eligibility engine, etc.) for a GenAI model in order to provide more detailed instructions as to how this criterion should be evaluated. In certain embodiments, these instructions are written in natural language and can be configured by a non-technical audience to offer domain-specific guidelines (e.g., medical domain, regulatory domain, manufacturing domain, etc.), definitions, and/or customized instructions so that evaluation is tailored to the features or situation of a particular user, domain (e.g., enterprise), and/or thing.

According to certain embodiments, after creating an eligibility-type object type that represents and captures requirements for an eligibility type and the associated criterion object types that represents and captures one or more criteria, the eligibility engine allows users to test the newly created assets by using the eligibility engine to evaluate manually selected individual entities to assess performance. In some embodiments, a criterion object type (e.g., criterion metadata, an object type including data fields for a criterion, etc.) can be updated in a testing environment to compare the performance of different instructions and parameters before updating the criterion object type in a production environment. In certain embodiments, the criterion object type is then used to perform automatic assessments that are triggered by user-configurable event or time conditions. For example, a trigger can be new orders received for a patient in a hospital.

According to some embodiments, the eligibility engine provides a framework for assessing eligibility by combining assessment of both structured and unstructured data. In certain embodiments, the eligibility engine's robust architecture that uses deterministic code, also referred to as functions, when possible and provides GenAI models with guardrails, tools, and precise instructions tailored for each criterion is a method (e.g., a unique method) for leveraging machine reasoning in important workflows while overcoming the unpredictable and stochastic nature of language models. In some embodiments, the eligibility engine includes features related to criteria creation, configuration, and iteration in a point-and-click user interface (UI) that allows non-technical users to configure natural language instructions and add both new and pre-existing criterion object types to an eligibility-type are a unique approach for their simplicity, case of use, and speed. In certain embodiments, the inclusion of features in the eligibility engine's architecture that allow GenAI models (e.g., LLMs) and functions (e.g., deterministic codes) to create links back to the source data used to evaluate criteria are also interesting for their ability to offer increased transparency within AI-powered applications that are typically believed to be opaque (e.g., in a black box). For example, the eligibility engine links an LLM's evaluation to the free-text note(s) it used in its assessment, along with a citation offered by the LLM with the particular quotes from the note(s) it used for the purposes of auditing, evaluation, and trust.

According to certain embodiments, the eligibility evaluation system (e.g., a software module, a software system) can include and/or access one or more computing models (e.g., one or more artificial intelligence (AI) models), also referred to as eligibility evaluation models, for generating and/or modifying one or more documents. In some embodiments, a model, also referred to as a computing model, includes a model to process data. A model includes, for example, an artificial intelligence (AI) model, a machine learning (ML) model, a deep learning (DL) model, an image processing model, an algorithm, a rule, other computing models, and/or a combination thereof. In certain embodiments, a eligibility evaluation AI model can generate and/or modify one or more documents (e.g., letters, appeal letters).

In certain examples, an eligibility evaluation AI model can include an existing large language model (e.g., GPT 40, etc.). In some examples, an eligibility evaluation AI model can be trained using a large amount of training data. In some embodiments, the eligibility evaluation AI model includes a generative AI (artificial intelligence) model that is trained using a large amount of training data. In certain embodiments, a generative AI model is a type of AI model that can be used to produce various type of content, such as text, images, videos, audio, 3D (three-dimensional) data, 3D models, and/or the like. In some embodiments, a language model or a large language model (LLM), which is a type of GenAI models that can generate content (e.g., text, audio, video, or other form, etc.).

According to some embodiments, the eligibility evaluation AI model (e.g., a language model, an LLM, etc.) can be trained using selected corpus (e.g., historical inputs, historical criterion object types, historical eligibility-type object types, historical criterion evaluation objects, historical eligibility evaluation objects, historical prompt structures, historical prompts, historical functions, historical evaluation results, etc.). In certain embodiments, the eligibility evaluation AI model is configured to generate one or more documents based on one or more inputs (e.g., prompts). In some embodiments, the eligibility evaluation AI model includes one or more template specific LLMs. In some embodiments, a template refers to a document template for a document type. In certain embodiments, a template specific LLM refers to a large language model that includes specific parameters and/or prompts for the document type. In some examples, a prompt for a template specific LLM can include one or more template specific variables.

According to certain embodiments, the eligibility engine includes and/or associates with a plurality of computing models coupled in series and/or in parallel. In some embodiments, the eligibility engine includes a first GenAI model configured to extract one or more pieces of evidence from one or more data records (e.g., patient charts, patient records, etc.) of one or more data sources (e.g., healthcare systems, etc.) to generate one or more system prompts to be input into a second GenAI model. In certain embodiments, the eligibility engine includes a first criterion object type using the second GenAI model. In some embodiments, the eligibility engine uses the first GenAI model in instantiating the first criterion object type to generate the first criterion evaluation object. In certain embodiments, the eligibility engine generates and/or updates an eligibility-type object type that is associated with a plurality of criterion object types and at least one or more of the plurality of criterion object types use a respective GenAI model. In some embodiments, the eligibility engine generates and/or updates an eligibility-type object type that is associated with a plurality of criterion object types and at least one or more of the plurality of criterion object types use a respective function (e.g., deterministic code). In certain embodiments, a function, for example, a function to determine a value.

In some embodiments, the eligibility engine includes a GenAI model that can be a language model (“LM”) that may include an algorithm, rule, model, and/or other programmatic instructions that can predict the probability of a sequence of words or expressions (e.g., textual queries, summary, text strings, software code). In some embodiments, a language model may, given a starting text string (e.g., one or more words), predict the next word or expression in the sequence. In certain embodiments, a language model may calculate the probability of different word combinations and/or software code based on the patterns learned during training (e.g., based on a set of text data from books, articles, websites, audio files, software code, etc.).

In some embodiments, a language model may generate many combinations of one or more next words and/or expressions that are coherent and contextually relevant. In certain embodiments, a language model can be an artificial intelligence model that has been trained to understand, generate, and manipulate language (e.g., computing language expressions). In some embodiments, a language model can be useful for natural language processing, including receiving natural language prompts and providing natural language responses based on the text on which the model is trained. In certain embodiments, a language model may include an n-gram, exponential, positional, neural network, and/or other type of model. In some embodiments, a language model can be used to generate software code.

In certain embodiments, the eligibility engine includes a GenAI model that can be a large language model (LLM), which was trained on a large data set and has a large number of parameters (e.g., billions of parameters, trillions of parameters, etc.). In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pretrained Transformer 3 (GPT-3) model, a GPT 3.5-turbo model, a GPT-4 model, a Claude model, a command-xlang model, a bidirectional encoder representations from transformers (BERT) model, a pathways language model (PaLM) 2, and/or the like.

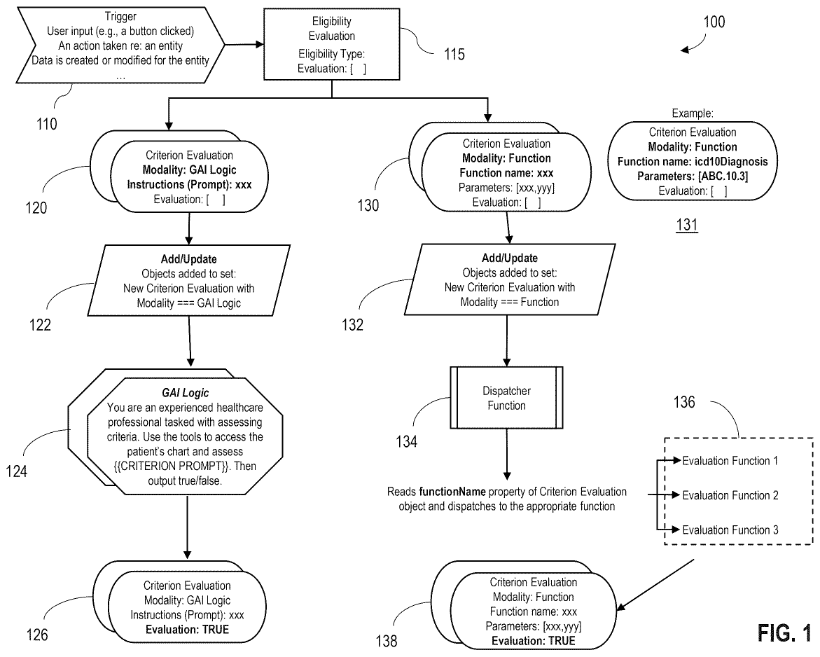

FIG. 1 is a simplified diagram showing a software architecture and/or workflow 100 for eligibility evaluation according to certain embodiments of the present disclosure. This diagram is merely an example. One of ordinary skill in the art would recognize many variations, alternatives, and modifications. The software architecture and/or workflow 100 includes components and/or processes 110, 115, 120, 122, 124, 126, 130, 131, 132, 134, 136, and 138. Although the above has been shown using a selected group of components and processes for the software architecture 100 for eligibility evaluation, there can be many alternatives, modifications, and variations. For example, some of the processes may be expanded and/or combined. Other components and processes may be inserted to those noted above. Depending upon the embodiment, the sequence of processes may be changed, and one or more components and processes may be replaced. Further details of these components and processes are found throughout the present disclosure.

According to certain embodiments, the eligibility engine receives an evaluation trigger at process 110. In some embodiments, the evaluation trigger can be a user input (e.g., a button clicked), an action taken regarding an entity, data is created and/or modified for the entity, and/or the like. In certain embodiments, the eligibility evaluation object 115 is an instantiation of the eligibility-type object type. In some embodiments, the eligibility evaluation object 115 links to one or more criterion evaluation objects 120 (e.g., representing 5 criteria) that have criterion evaluation modalities of GenAI evaluation modalities. In certain embodiments, the eligibility evaluation object 115 links to one or more criterion evaluation objects 130 (e.g., representing 5 criteria) that have criterion evaluation modalities of function evaluation modalities.

According to some embodiments, each criterion evaluation object 120 includes one or more of a criterion name, a criterion description, an evaluation modality, one or more instructions (e.g., prompts), an evaluation result, and/or the like. In certain embodiments, the eligibility engine adds and/or updates the criterion evaluation objects 122. In some embodiments, the eligibility engine generates a query prompt 124 and provides it to a GenAI model. In certain embodiments, the eligibility engine receives one or more criterion evaluation objects 126 including the associated metadata, and/or produces or updates evaluation result.

According to certain embodiments, a criterion evaluation object 130 includes one or more of a criterion name, a criterion description, an evaluation modality, one or more instructions (e.g., function name, parameters), an evaluation result, and/or the like, for example, as illustrated in the criterion evaluation object 131. In certain embodiments, the eligibility engine adds and/or updates the criterion evaluation objects 132. In some embodiments, the eligibility engine dispatches one or more functions 134. In certain embodiments, the eligibility engine runs the evaluation functions 136. In certain embodiments, the eligibility engine generates one or more criterion evaluation objects 138 including evaluation results. In some embodiments, the eligibility engine generates an eligibility result based on the one or more criterion evaluation objects 126 and one or more criterion evaluation objects 138.

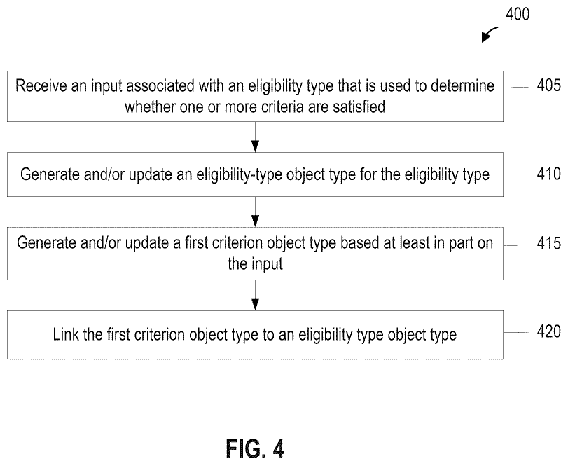

FIG. 4 is a simplified diagram showing a method 400 for eligibility evaluation according to certain embodiments of the present disclosure. This diagram is merely an example. One of ordinary skill in the art would recognize many variations, alternatives, and modifications. The method 400 includes processes 405, 410, 415, and 420. Although the above has been shown using a selected group of processes for the method 400, there can be many alternatives, modifications, and variations. For example, some of the processes may be expanded and/or combined. Other processes may be inserted to those noted above. Depending upon the embodiment, the sequence of processes may be changed, and one or more processes may be replaced. Further details of these processes are found throughout the present disclosure.

In some embodiments, some or all processes (e.g., steps) of the method 400 are performed by a system (e.g., the computing system 900). In certain examples, some or all processes (e.g., steps) of the method 400 are performed by a computer and/or a processor directed by a code. For example, a computer includes a server computer and/or a client computer (e.g., a personal computer). In some examples, some or all processes (e.g., steps) of the method 400 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at process 405, the system receives an input associated with an eligibility type that is used to determine whether one or more criteria are satisfied. In some embodiments, for an eligibility type, the system receives one or more criteria and their corresponding instructions about how the corresponding one or more criteria ought to be evaluated (e.g., their respective general evaluation modality, such as deterministic code and/or large language model).

In some embodiments, at process 410, the system generates and/or updates an eligibility-type object type for the eligibility type. In certain embodiments, the eligibility-type object type links to a plurality of criterion object types. In some embodiments, a criterion object type, also referred to as a criterion metadata object, is an object type including one or more data fields for a criterion. In certain embodiments, the one or more data fields of a criterion object type include, for example, a data field of a criterion name, a data field of a criterion description, a data field for a criterion evaluation modality, one or more data fields for an instruction related to the criterion evaluation, and/or the like. In some embodiments, a criterion evaluation modality includes at least one selected from a group consisting of a generative artificial intelligence (GenAI) evaluation modality and a function evaluation modality.

According to some embodiments, for a criterion object type having a criterion evaluation modality as a GenAI evaluation modality, the criterion object type includes one or more data fields for a prompt structure, a criterion prompt input, a software tool, and/or the like. In certain embodiments, the software tool provides access to one or more data sources. In some embodiments, the eligibility engine can only access data associated to an entity (e.g., patient records, organization data, etc.) that it has been granted access to (e.g., following a formal review process for determining whether personal data can be made available to the eligibility engine) via the software tool. In certain embodiments, the software tool is used to process data. In some embodiments, the criterion object type includes software code to extract data (e.g., specific symptoms of a person, etc.) from the one or more data sources.

In certain embodiments, the criterion object type uses a first computing model (e.g., a first GenAI model, a first LLM, etc.) to extract data (e.g., specific symptoms of a person, etc.) from the one or more data sources. In some embodiments, the criterion object type uses a second computing model (e.g., a second GenAI model, a second LLM, etc.) to construct a query prompt based on the prompt structure, the prompt input, the extracted data, and/or the indication of the software tool. In certain embodiments, the second computing model is different from the first computing model. In some embodiments, the system provides the constructed query prompt to a third computing model (e.g., a third GenAI model, a third LLM, etc.) to generate an evaluation result. In certain embodiments, the criterion object type includes a data field for an indication of a selected computing model, such that the third computing model is the selected computing model. In some embodiments, the criterion evaluation result includes a Boolean value. In certain embodiments, the criterion evaluation result includes a text string. In some embodiments, the criterion evaluation result includes a criterion evaluation explanation.

According to certain embodiments, for a criterion object type having a criterion evaluation modality as a function evaluation modality, the criterion object type includes one or more data fields for an indication of a function (e.g., a function name), one or more parameters of the function, a software tool, and/or the like. In certain embodiments, the software tool provides access to one or more data sources. In some embodiments, the criterion object type includes software code to extract data (e.g., a physiology measure of a person, etc.) from the one or more data sources. In some embodiments, the eligibility engine can only access data associated to an entity (e.g., patient records, organization data, etc.) that it has been granted access to (e.g., following a formal review process for determining whether personal data can be made available to the eligibility engine) via the software tool.

In certain embodiments, the criterion object type uses a first computing model (e.g., a first GenAI model, a first LLM, etc.) to extract data (e.g., specific symptoms of a person, etc.) from the one or more data sources. In some embodiments, the criterion object type uses the function on the extracted data to generate an evaluation result. For example, the function is to determine whether a patient has stayed in the hospital longer than a threshold. In some embodiments, the criterion evaluation result includes a Boolean value. In certain embodiments, the criterion evaluation result includes a text string. In some embodiments, the criterion evaluation result includes a criterion evaluation explanation.

In certain embodiments, the eligibility-type object type includes function to aggregate the plurality of criterion evaluation results generated using the plurality of criterion object types to generate the eligibility result. In some embodiments, the plurality of criterion object types are prioritized. In certain embodiments, the plurality of criterion object types are prioritized by ranking. In some embodiments, at least one of the plurality of criterion object types is optional.

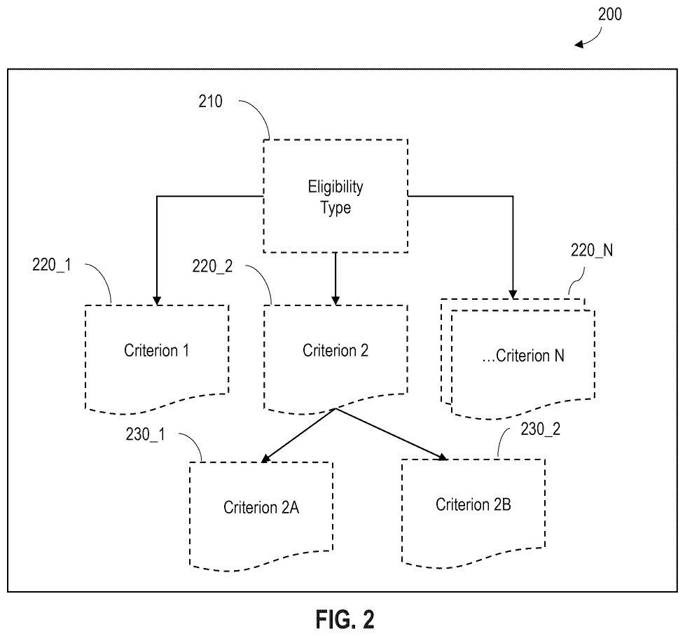

FIG. 2 is an example of object types 200 according to certain embodiments of the present disclosure. FIG. 2 is merely an example. One of ordinary skill in the art would recognize many variations, alternatives, and modifications. In this example, the eligibility-type object type 210 links to (e.g., associates with) the criterion object type 220_1, the criterion object type 220_2, . . . and the criterion object type 220_N. In certain examples, the object types are linked by identifiers (IDs). In some examples, the criterion object type 220_2 links to (e.g., associates with) the criterion object type 230_1 and the criterion object type 230_2 (e.g., child object).

According to some embodiments, at process 415, the system generates and/or updates a first criterion object type based at least in part on the input. In certain embodiments, the system selects the first criterion object type from a criterion object type repository (e.g., criterion object bank) and updates the first criterion object type based at least in part on the input. In some embodiments, the system generates the first criterion object type based at least in part on the input. In certain embodiments, the input includes an indication of a source of policy, and the system is configured to extract one or more rules from the source of policy. In some embodiments, the system generates the first criterion object type based at least in part on at least one of the one or more extracted rules.

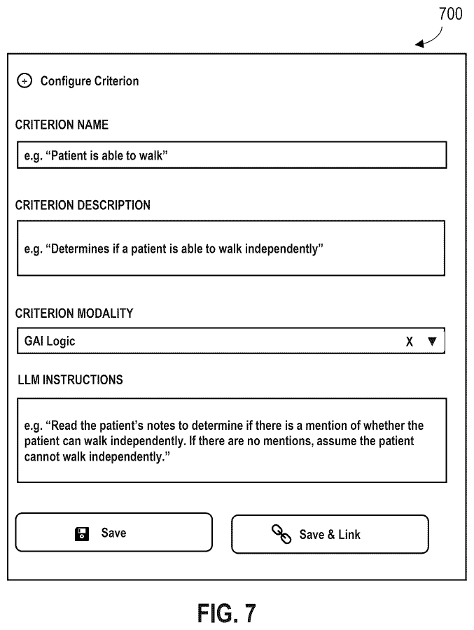

According to certain embodiments, at process 420, the system links the first criterion object type to the eligibility-type object type. In some embodiments, the eligibility-type object type is associated with a plurality of criterion object types including the first criterion object type, for example, as illustrated in FIG. 2. In certain embodiments, the plurality of criterion object types include a second criterion object type that is a child criterion type of the first criterion object type. In some embodiments, the plurality of criterion object types include the first criterion object type that is a child criterion type of a second criterion object type. In certain embodiments, the plurality of criterion object types include a second criterion object type that is a parent criterion type of the first criterion object type. In some embodiments, the plurality of criterion object types include the first criterion object type that is a parent criterion type of a second criterion object type. FIG. 7 is an example user interface of generating and/or updating a criterion according to certain embodiments of the present disclosure. FIG. 7 is merely an example. One of ordinary skill in the art would recognize many variations, alternatives, and modifications. In this example, a user (e.g., an administrative user, etc.) can add and/or edit the criterion name, the criterion description, the criterion evaluation modality, and/or the instruction.

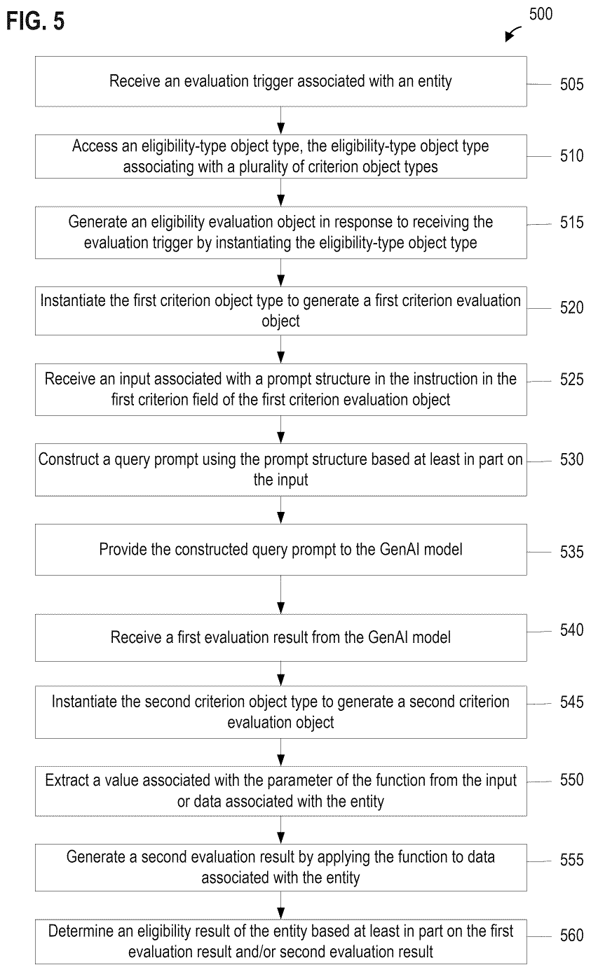

FIG. 5 is a simplified diagram showing a method 500 for eligibility evaluation according to certain embodiments of the present disclosure. This diagram is merely an example. One of ordinary skill in the art would recognize many variations, alternatives, and modifications. The method 500 includes processes 505, 510, 515, 520, 525, 530, 535, 540, 545, 550, 555, and 560. Although the above has been shown using a selected group of processes for the method 500, there can be many alternatives, modifications, and variations. For example, some of the processes may be expanded and/or combined. Other processes may be inserted to those noted above. Depending upon the embodiment, the sequence of processes may be changed, and one or more processes may be replaced. Further details of these processes are found throughout the present disclosure.

In some embodiments, some or all processes (e.g., steps) of the method 500 are performed by a system (e.g., the computing system 900). In certain examples, some or all processes (e.g., steps) of the method 500 are performed by a computer and/or a processor directed by a code. For example, a computer includes a server computer and/or a client computer (e.g., a personal computer). In some examples, some or all processes (e.g., steps) of the method 500 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at process 505, the system receives an evaluation trigger associated with an entity. In some embodiments, the entity can be a person, an organization, a thing, and/or the like. In certain embodiments, the evaluation trigger is a time-based trigger (e.g., every periodic time, every 3 months, etc.). In some embodiments, the evaluation trigger is an event-based trigger. For example, an event-based trigger includes clicking a button (e.g., an “evaluate” button) in application, placing a new order for a patient, creating a new note (e.g., record, etc.) for a patient, and/or the like.

According to some embodiments, at process 510, the system accesses an eligibility-type object type, where the eligibility-type object type is associated with a plurality of criterion object types. In certain embodiments, the plurality of criterion object types include a first criterion object type and a second criterion object type. In some embodiments, the first criterion object type includes a first criterion field for an indication of a criterion evaluation modality and a second criterion field for an indication of an instruction.

According to certain embodiments, at process 515, the system generates an eligibility evaluation object in response to receiving the evaluation trigger by instantiating the eligibility-type object type. In some embodiments, at process 520, the system instantiates the first criterion object type to generate a first criterion evaluation object, where the indication of the criterion evaluation modality in the first criterion field of the first criterion evaluation object indicating a GenAI evaluation modality, and the first criterion evaluation object links to the eligibility evaluation object.

According to some embodiments, at process 525, the system receives an input associated with a prompt structure in the instruction in the first criterion field of the first criterion evaluation object. In certain embodiments, the system receives an input associated with the GenAI model and selects the GenAI model based on the input associated with the GenAI model. In some examples, the input includes a text stream to be input into the prompt structure. In certain embodiments, at process 530, the system constructs a query prompt using the prompt structure based at least in part on the input. In some embodiments, at process 535, the system provides the constructed query prompt to the GenAI model. In some embodiments, the system identifies a software tool associated with the first criterion object type. In certain embodiments, the system constructs the query prompt based at least in part on the identified software tool, where the constructed query prompt includes an indication of the identified software tool. In some embodiments, the software tool allows access to data of the entity, where the constructed query prompt includes data of the entity and/or the software tool. In some embodiments, the eligibility engine can only access data associated to the entity (e.g., patient records, organization data, etc.) that it has been granted access to (e.g., following a formal review process for determining whether personal data can be made available to the eligibility engine) via the software tool.

According to certain embodiments, at process 540, the system receives a first evaluation result from the GenAI model. In some embodiments, the plurality of criterion object types include a second criterion object type, where the second criterion object type includes a first criterion field for an indication of a criterion evaluation modality and a second criterion field for an indication of an instruction, where the first criterion field of the second criterion evaluation object indicates a function evaluation modality. In certain embodiments, at process 545, the system instantiates the second criterion object type to generate a second criterion evaluation object, where the second criterion evaluation object has a link to the eligibility evaluation object. In some embodiments, the second criterion field of the second criterion evaluation object includes a value for a parameter of a function that is used for eligibility evaluation.

According to certain embodiments, at process 550, the system extracts a value associated with the parameter of the function from the input or data associated with the entity. In some examples, the extracted value is a numerical value. In some embodiments, the system uses a software tool identified in the entity evaluation object and/or one or more of the criterion evaluation objects to access data of the entity. In certain embodiments, the software tool has access to data of the entity.

According to some embodiments, at process 555, the system generates a second evaluation result by applying the function to data associated with the entity. In certain embodiments, at process 560, the system determines an eligibility result of the entity based at least in part on the first evaluation result and/or the second evaluation result. In some embodiments, the eligibility evaluation object is associated with a plurality of criterion evaluation objects (e.g., 5, 7, 10, etc.), and the system is configured to determine the eligibility result based on the plurality of evaluation results corresponding to the plurality of criterion evaluation objects.

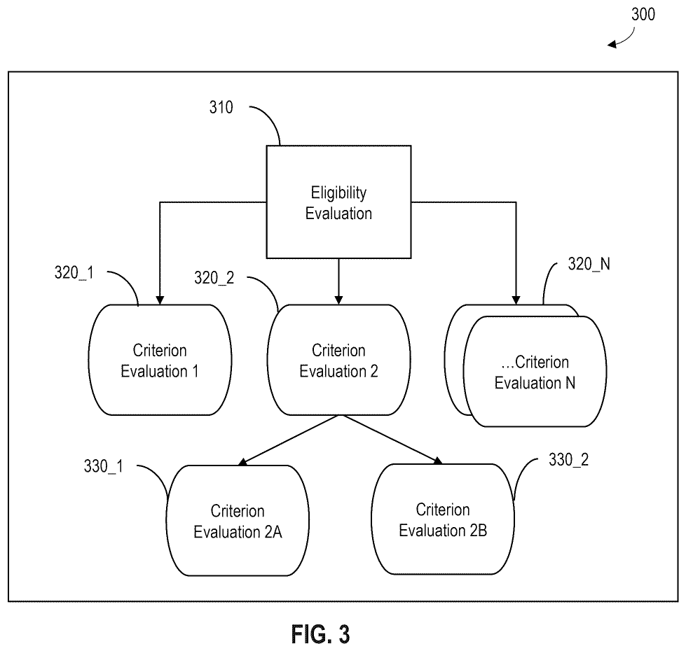

FIG. 3 is an example of evaluation objects 300 according to certain embodiments of the present disclosure. FIG. 3 is merely an example. One of ordinary skill in the art would recognize many variations, alternatives, and modifications. In this example, the eligibility evaluation object 310 (e.g., instantiated from the eligibility-type object type 210) links to (e.g., associates with) the criterion evaluation object 320_1, the criterion evaluation object 320_2, . . . and the criterion evaluation object 320_N. In certain examples, the object types are linked by identifiers (IDs). In some examples, the criterion evaluation object 320_2 links to (e.g., associates with) the criterion evaluation object 330_1 and the criterion evaluation object 330_2 (e.g., child object).

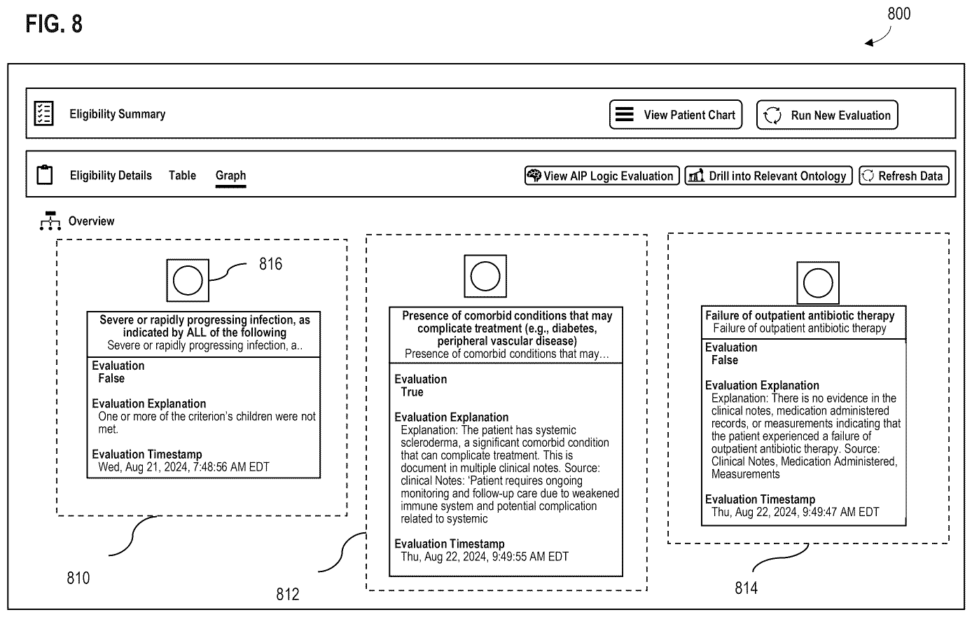

FIG. 8 is an example user interface 800 of eligibility evaluation according to certain embodiments of the present disclosure. FIG. 8 is merely an example. One of ordinary skill in the art would recognize many variations, alternatives, and modifications. In this example, the user interface 800 includes the criterion evaluation objects 810, 812, and 814, where each evaluation object includes an evaluation description, an evaluation result, an evaluation explanation, and an evaluation timestamp. In this example, each evaluation object has an evaluation result indication 816 (e.g., color, pattern, etc.) indicating the evaluation result.

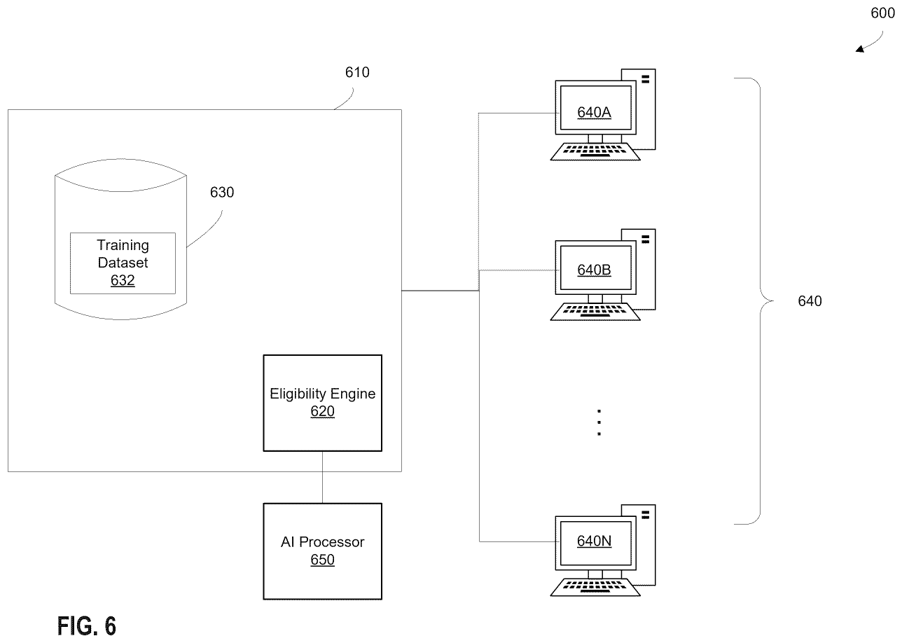

FIG. 6 is an illustrative eligibility evaluation environment 600 according to certain embodiments of the present disclosure. FIG. 6 is merely an example. One of ordinary skill in the art would recognize many variations, alternatives, and modifications. In some embodiments, the eligibility evaluation environment 600 includes one or more eligibility evaluation system 610 and one or more computing devices 640 (e.g., computing device 640A, computing device 640B, . . . computing device 640N, etc.). In certain embodiments, the eligibility evaluation system 610 includes one or more eligibility evaluation processor 620s, one or more evidence processors 622, one or more displays 627, and one or more data repositories 630.

In some embodiments, the one or more data repositories 630 include one or more training datasets 662, for example, for one or more eligibility evaluation AI models. In certain embodiments, the computing device 640 may include and/or access at least a part of the functionality of the eligibility evaluation system 610. In certain embodiments, the eligibility evaluation processors 620 interacts with one or more AI processors 650 (e.g., AI servers). For example, the eligibility evaluation processor 620 provides one or more constructed prompts to the one or more AI processors 650 to generate outputs (e.g., evaluation results, evaluation explanations, etc.). Although the above has been shown using a selected group of components in the eligibility evaluation environment 600, there can be many alternatives, modifications, and variations. For example, some of the components may be expanded and/or combined. Other components may be inserted into those noted above. Depending upon the embodiment, the arrangement of components may be interchanged with others replaced. Further details of these components are found throughout the present disclosure.

According to certain embodiments, the eligibility evaluation system 610 and/or the eligibility evaluation processor 620 receives an input associated with an eligibility type that is used to determine whether one or more criteria are satisfied. In some embodiments, for an eligibility type, the eligibility evaluation system 610 and/or the eligibility evaluation processor 620 receives one or more criteria and their corresponding instructions about how the corresponding one or more criteria ought to be evaluated (e.g., their respective general evaluation modality, such as deterministic code and/or large language model).

In some embodiments, the eligibility evaluation system 610 and/or the eligibility evaluation processor 620 generates and/or updates an eligibility-type object type for the eligibility type. In certain embodiments, the eligibility-type object type links to a plurality of criterion object types. In some embodiments, a criterion object type, also referred to as a criterion metadata object, is an object type including one or more data fields for a criterion. In certain embodiments, the one or more data fields of a criterion object type include, for example, a data field of a criterion name, a data field of a criterion description, a data field for a criterion evaluation modality, one or more data fields for an instruction related to the criterion evaluation, and/or the like. In some embodiments, a criterion evaluation modality includes at least one selected from a group consisting of a generative artificial intelligence (GenAI) evaluation modality and a function evaluation modality.

According to some embodiments, for a criterion object type having a criterion evaluation modality as a GenAI evaluation modality, the criterion object type includes one or more data fields for a prompt structure, a criterion prompt input, a software tool, and/or the like. In certain embodiments, the software tool provides access to one or more data sources. In certain embodiments, the software tool is used to process data. In some embodiments, the criterion object type includes software code to extract data (e.g., specific symptoms of a person, etc.) from the one or more data sources. In some embodiments, the eligibility engine can only access data associated to an entity (e.g., patient records, organization data, etc.) that it has been granted access to (e.g., following a formal review process for determining whether personal data can be made available to the eligibility engine) via the software tool.

In certain embodiments, the criterion object type uses a first computing model (e.g., a first GenAI model, a first LLM, etc.) to extract data (e.g., specific symptoms of a person, etc.) from the one or more data sources. In some embodiments, the criterion object type uses a second computing model (e.g., a second GenAI model, a second LLM, etc.) to construct a query prompt based on the prompt structure, the prompt input, the extracted data, and/or the indication of the software tool. In certain embodiments, the second computing model is different from the first computing model. In some embodiments, the eligibility evaluation system 610 and/or the eligibility evaluation processor 620 provides the constructed query prompt to a third computing model (e.g., a third GenAI model, a third LLM, etc.) to generate an evaluation result. In some embodiments, the eligibility evaluation system 610 and/or the eligibility evaluation processor 620 provides the constructed query prompt to a third computing model (e.g., a third GenAI model, a third LLM, etc.) run on the one or more AI processors 650 to generate an evaluation result. In certain embodiments, the criterion object type includes a data field for an indication of a selected computing model, such that the third computing model is the selected computing model. In some embodiments, the criterion evaluation result includes a Boolean value. In certain embodiments, the criterion evaluation result includes a text string. In some embodiments, the criterion evaluation result includes a criterion evaluation explanation.

According to certain embodiments, for a criterion object type having a criterion evaluation modality as a function evaluation modality, the criterion object type includes one or more data fields for an indication of a function (e.g., a function name), one or more parameters of the function, a software tool, and/or the like. In certain embodiments, the software tool provides access to one or more data sources. In some embodiments, the criterion object type includes software code to extract data (e.g., a physiology measure of a person, etc.) from the one or more data sources. In some embodiments, the eligibility engine can only access data associated to an entity (e.g., patient records, organization data, etc.) that it has been granted access to (e.g., following a formal review process for determining whether personal data can be made available to the eligibility engine) via the software tool.

In certain embodiments, the criterion object type uses a first computing model (e.g., a first GenAI model, a first LLM, etc.) to extract data (e.g., specific symptoms of a person, etc.) from the one or more data sources. In some embodiments, the criterion object type uses the function on the extracted data to generate an evaluation result. For example, the function is to determine whether a patient has stayed in the hospital longer than a threshold. In some embodiments, the criterion evaluation result includes a Boolean value. In certain embodiments, the criterion evaluation result includes a text string. In some embodiments, the criterion evaluation result includes a criterion evaluation explanation.

In certain embodiments, the eligibility-type object type includes function to aggregate the plurality of criterion evaluation results generated using the plurality of criterion object types to generate the eligibility result. In some embodiments, the plurality of criterion object types are prioritized. In certain embodiments, the plurality of criterion object types are prioritized by ranking. In some embodiments, at least one of the plurality of criterion object types is optional.

FIG. 2 is an example of object types 200 according to certain embodiments of the present disclosure. FIG. 2 is merely an example. One of ordinary skill in the art would recognize many variations, alternatives, and modifications. In this example, the eligibility-type object type 210 links to (e.g., associates with) the criterion object type 220_1, the criterion object type 220_2, . . . and the criterion object type 220_N. In certain examples, the object types are linked by identifiers (IDs). In some examples, the criterion object type 220_2 links to (e.g., associates with) the criterion object type 230_1 and the criterion object type 230_2 (e.g., child object).

According to some embodiments, the eligibility evaluation system 610 and/or the eligibility evaluation processor 620 generates and/or updates a first criterion object type based at least in part on the input. In certain embodiments, the eligibility evaluation system 610 and/or the eligibility evaluation processor 620 selects the first criterion object type from a criterion object type repository (e.g., criterion object bank) and updates the first criterion object type based at least in part on the input. In some embodiments, the eligibility evaluation system 610 and/or the eligibility evaluation processor 620 generates the first criterion object type based at least in part on the input. In certain embodiments, the input includes an indication of a source of policy, and the eligibility evaluation system 610 and/or the eligibility evaluation processor 620 is configured to extract one or more rules from the source of policy. In some embodiments, the eligibility evaluation system 610 and/or the eligibility evaluation processor 620 generates the first criterion object type based at least in part on at least one of the one or more extracted rules.

According to certain embodiments, the eligibility evaluation system 610 and/or the eligibility evaluation processor 620 links the first criterion object type to the eligibility-type object type. In some embodiments, the eligibility-type object type is associated with a plurality of criterion object types including the first criterion object type, for example, as illustrated in FIG. 2. In certain embodiments, the plurality of criterion object types include a second criterion object type that is a child criterion type of the first criterion object type. In some embodiments, the plurality of criterion object types include the first criterion object type that is a child criterion type of a second criterion object type. In certain embodiments, the plurality of criterion object types include a second criterion object type that is a parent criterion type of the first criterion object type. In some embodiments, the plurality of criterion object types include the first criterion object type that is a parent criterion type of a second criterion object type. FIG. 7 is an example user interface 700 of generating and/or updating a criterion according to certain embodiments of the present disclosure. FIG. 7 is merely an example. One of ordinary skill in the art would recognize many variations, alternatives, and modifications. In this example, a user (e.g., an administrative user, etc.) can add and/or edit the criterion name, the criterion description, the criterion evaluation modality, and/or the instruction.

According to certain embodiments, the eligibility evaluation system 610 and/or the eligibility evaluation processor 620 receives an evaluation trigger associated with an entity. In some embodiments, the entity can be a person, an organization, a thing, and/or the like. In certain embodiments, the evaluation trigger is a time-based trigger (e.g., every periodic time, every 3 months, etc.). In some embodiments, the evaluation trigger is an event-based trigger. For example, an event-based trigger includes clicking a button (e.g., an “evaluate” button) in application, placing a new order for a patient, creating a new note (e.g., record, etc.) for a patient, and/or the like.

According to some embodiments, the eligibility evaluation system 610 and/or the eligibility evaluation processor 620 accesses an eligibility-type object type, where the eligibility-type object type is associated with a plurality of criterion object types. In certain embodiments, the plurality of criterion object types include a first criterion object type and a second criterion object type. In some embodiments, the first criterion object type includes a first criterion field for an indication of a criterion evaluation modality and a second criterion field for an indication of an instruction.

According to certain embodiments, the eligibility evaluation system 610 and/or the eligibility evaluation processor 620 generates an eligibility evaluation object in response to receiving the evaluation trigger by instantiating the eligibility-type object type. In some embodiments, the eligibility evaluation system 610 and/or the eligibility evaluation processor 620 instantiates the first criterion object type to generate a first criterion evaluation object, where the indication of the criterion evaluation modality in the first criterion field of the first criterion evaluation object indicating a GenAI evaluation modality, and the first criterion evaluation object links to the eligibility evaluation object.

According to some embodiments, the eligibility evaluation system 610 and/or the eligibility evaluation processor 620 receives an input associated with a prompt structure in the instruction in the first criterion field of the first criterion evaluation object. In certain embodiments, the eligibility evaluation system 610 and/or the eligibility evaluation processor 620 receives an input associated with the GenAI model and selects the GenAI model based on the input associated with the GenAI model. In some examples, the input includes a text stream to be input into the prompt structure. In certain embodiments, the eligibility evaluation system 610 and/or the eligibility evaluation processor 620 constructs a query prompt using the prompt structure based at least in part on the input. In some embodiments, the eligibility evaluation system 610 and/or the eligibility evaluation processor 620 provides the constructed query prompt to the GenAI model. In certain embodiments, the eligibility evaluation system 610 and/or the eligibility evaluation processor 620 provides the constructed query prompt to the GenAI model running on the one or more AI processors 650. In some embodiments, the eligibility evaluation system 610 and/or the eligibility evaluation processor 620 identifies a software tool associated with the first criterion object type. In certain embodiments, the eligibility evaluation system 610 and/or the eligibility evaluation processor 620 constructs the query prompt based at least in part on the identified software tool, where the constructed query prompt includes an indication of the identified software tool. In some embodiments, the software tool allows access to data of the entity, where the constructed query prompt includes data of the entity and/or the software tool. In some embodiments, the eligibility engine can only access data associated to the entity (e.g., patient records, organization data, etc.) that it has been granted access to (e.g., following a formal review process for determining whether personal data can be made available to the eligibility engine) via the software tool.

According to certain embodiments, the eligibility evaluation system 610 and/or the eligibility evaluation processor 620 receives a first evaluation result from the GenAI model. In some embodiments, the plurality of criterion object types include a second criterion object type, where the second criterion object type includes a first criterion field for an indication of a criterion evaluation modality and a second criterion field for an indication of an instruction, where the first criterion field of the second criterion evaluation object indicates a function evaluation modality. In certain embodiments, the eligibility evaluation system 610 and/or the eligibility evaluation processor 620 instantiates the second criterion object type to generate a second criterion evaluation object, where the second criterion evaluation object has a link to the eligibility evaluation object. In some embodiments, the second criterion field of the second criterion evaluation object includes a value for a parameter of a function that is used for eligibility evaluation.

According to certain embodiments, the eligibility evaluation system 610 and/or the eligibility evaluation processor 620 extracts a value associated with the parameter of the function from the input or data associated with the entity. In some examples, the extracted value is a numerical value. In some embodiments, the eligibility evaluation system 610 and/or the eligibility evaluation processor 620 uses a software tool identified in the entity evaluation object and/or one or more of the criterion evaluation objects to access data of the entity. In certain embodiments, the software tool has access to data of the entity. In some embodiments, the eligibility engine can only access data associated to an entity (e.g., patient records, organization data, etc.) that it has been granted access to (e.g., following a formal review process for determining whether personal data can be made available to the eligibility engine) via the software tool.

According to some embodiments, the eligibility evaluation system 610 and/or the eligibility evaluation processor 620 generates a second evaluation result by applying the function to data associated with the entity. In certain embodiments, the eligibility evaluation system 610 and/or the eligibility evaluation processor 620 determines an eligibility result of the entity based at least in part on the first evaluation result and/or the second evaluation result. In some embodiments, the eligibility evaluation object is associated with a plurality of criterion evaluation objects (e.g., 5, 7, 10, etc.), and the eligibility evaluation system 610 and/or the eligibility evaluation processor 620 is configured to determine the eligibility result based on the plurality of evaluation results corresponding to the plurality of criterion evaluation objects.

FIG. 3 is an example of evaluation objects 300 according to certain embodiments of the present disclosure. FIG. 3 is merely an example. One of ordinary skill in the art would recognize many variations, alternatives, and modifications. In this example, the eligibility evaluation object 310 (e.g., instantiated from the eligibility-type object type 210) links to (e.g., associates with) the criterion evaluation object 320_1, the criterion evaluation object 320_2, . . . and the criterion evaluation object 320_N. In certain examples, the object types are linked by identifiers (IDs). In some examples, the criterion evaluation object 320_2 links to (e.g., associates with) the criterion evaluation object 330_1 and the criterion evaluation object 330_2 (e.g., child object).

FIG. 8 is an example user interface 800 of eligibility evaluation according to certain embodiments of the present disclosure. FIG. 8 is merely an example. One of ordinary skill in the art would recognize many variations, alternatives, and modifications. In this example, the user interface 800 includes the criterion evaluation objects 810, 812, and 814, where each evaluation object includes an evaluation description, an evaluation result, an evaluation explanation, and an evaluation timestamp. In this example, each evaluation object has an evaluation result indication 816 (e.g., color, pattern, etc.) indicating the evaluation result.

In some embodiments, the one or more repositories 630 can include one or more training datasets 662, one or more eligibility evaluation AI models, one or more parameters and weight values for the one or more eligibility evaluation AI models, inputs, functions, criterion object types, criterion evaluation objects, eligibility-type object types, eligibility evaluation objects, prompt templates (e.g., prompt structures), prompts, functions, evaluation results, and/or the like. The repository may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the eligibility evaluation environment 600 can execute software or firmware stored in non-transitory computer-readable medium to implement various processing steps. Various components and processors of the eligibility evaluation environment 600 can be implemented by one or more computing devices including, but not limited to, circuits, a computer, a cloud-based processing unit, a processor, a processing unit, a microprocessor, a mobile computing device, and/or a tablet computer. In some cases, various components referenced by the eligibility evaluation environment 600 (e.g., the one or more eligibility evaluation systems 610, the one or more eligibility evaluation processors 620, the one or more computing devices 640, the one or more AI processors 650, etc.) can be implemented on a shared computing device. Alternatively, a component of the eligibility evaluation environment 600 can be implemented on multiple computing devices. In some implementations, various modules and components referenced by the eligibility evaluation environment 600 can be implemented as software, hardware, firmware, or a combination thereof. In some cases, various components referenced by the eligibility evaluation environment 600 can be implemented in software or firmware executed by a computing device.

Various components referenced by eligibility evaluation environment 600 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as an intranet, or on a public computer network, such as the Internet.

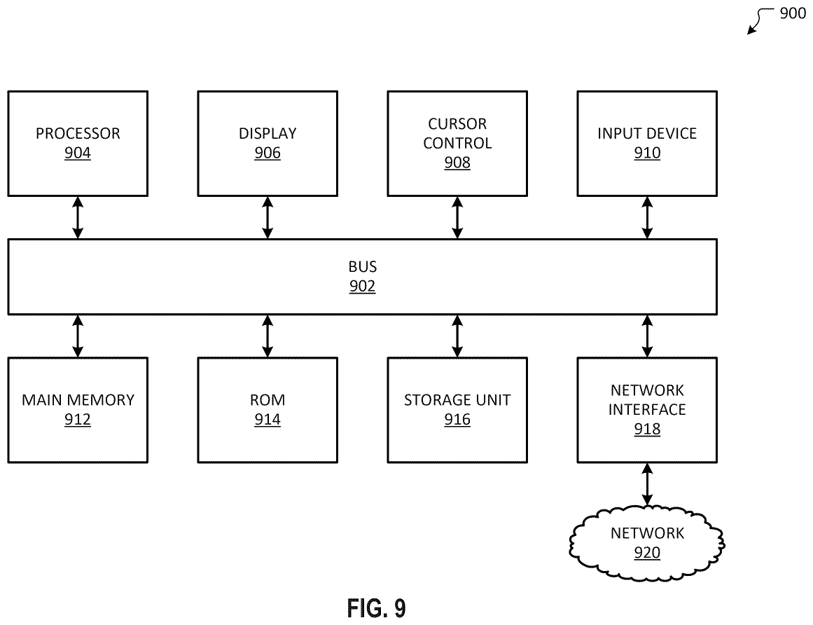

FIG. 9 is a simplified diagram showing a computing system for implementing a system 900 for eligibility evaluation in accordance with at least one example set forth in the disclosure. This diagram is merely an example, which should not unduly limit the scope of the claims. One of ordinary skill in the art would recognize many variations, alternatives, and modifications.

The computing system 900 includes a bus 902 or other communication mechanism for communicating information, a processor 904, a display 906, a cursor control component 908, an input device 910, a main memory 912, a read only memory (ROM) 914, a storage unit 916, and a network interface 918. In some embodiments, some or all processes (e.g., steps) of the methods (e.g., the method 400, the method 500, etc.) and processes described in the present disclosure are performed by the computing system 900. In some examples, the bus 902 is coupled to the processor 904, the display 906, the cursor control component 908, the input device 910, the main memory 912, the read only memory (ROM) 914, the storage unit 916, and/or the network interface 918. In certain examples, the network interface is coupled to a network 920. For example, the processor 904 includes one or more general purpose microprocessors. In some examples, the main memory 912 (e.g., random access memory (RAM), cache and/or other dynamic storage devices) is configured to store information and instructions to be executed by the processor 904. In certain examples, the main memory 912 is configured to store temporary variables or other intermediate information during execution of instructions to be executed by processor 904. For example, the instructions, when stored in the storage unit 916 accessible to processor 904, render the computing system 900 into a special-purpose machine that is customized to perform the operations specified in the instructions. In some examples, the ROM 914 is configured to store static information and instructions for the processor 904. In certain examples, the storage unit 916 (e.g., a magnetic disk, optical disk, or flash drive) is configured to store information and instructions.

In some embodiments, the display 906 (e.g., a cathode ray tube (CRT), an LCD display, or a touch screen) is configured to display information to a user of the computing system 900. In some examples, the input device 910 (e.g., alphanumeric and other keys) is configured to communicate information and commands to the processor 904. For example, the cursor control component 908 (e.g., a mouse, a trackball, or cursor direction keys) is configured to communicate additional information and commands (e.g., to control cursor movements on the display 906) to the processor 904.

According to certain embodiments, a method for eligibility evaluation, the method comprising: receiving an input associated with an eligibility type that is used to determine whether one or more criteria are satisfied; generating a first criterion object type based at least in part on the input and being associated with at least one of the one or more criteria, the first criterion object type including a first criterion field for an indication of a criterion evaluation modality and a second criterion field for an indication of an instruction, the criterion evaluation modality including at least one selected from a group consisting of a generative artificial intelligence (GenAI) evaluation modality and a function evaluation modality; and linking the first criterion object type to an eligibility-type object type representing the eligibility type, the eligibility-type object type associating with a plurality of criterion object types including the first criterion object type; wherein the method is performed by one or more processors. For example, the method is implemented according to at least FIG. 1, FIG. 2, FIG. 3, FIG. 4, FIG. 5, and/or FIG. 6.

In some embodiments, the generating a first criterion object type includes: selecting the first criterion object type from a criterion object type repository; and updating the first criterion object type based at least in part on the input. In some embodiments, the plurality of criterion object types include a second criterion object type that is a child criterion type of the first criterion object type. In some embodiments, the plurality of criterion object types include a second criterion object type that is a parent criterion type of the first criterion object type. In some embodiments, the indication of the criterion evaluation modality of the first criterion object type is a GenAI evaluation modality; wherein the method further comprises updating the instruction of the second criterion field of the first criterion object type based at least in part on the input; wherein the instruction of the second criterion field of the first criterion object type includes a prompt structure.

In some embodiments, the input includes an indication of a source of policy; wherein the method further comprises extracting one or more rules from the source of policy; wherein the generating a first criterion object type based at least in part on the input comprises generating the first criterion object type based at least in part on at least one of the one or more extracted rules. In some embodiments, first criterion object type includes a third criterion field for a criterion name. In some embodiments, the first criterion object type includes a fourth criterion field for an evaluation explanation for a corresponding criterion. In some embodiments, the plurality of criterion object types are prioritized by a ranking; wherein at least one of the plurality of criterion object types is optional.

According to some embodiments, a method for eligibility evaluation, the method comprising: receiving an evaluation trigger associated with an entity; accessing an eligibility-type object type, the eligibility-type object type associating with a plurality of criterion object types, a first criterion object type of the plurality of criterion object types including a first criterion field for an indication of a criterion evaluation modality and a second criterion field for an indication of an instruction; generating an eligibility evaluation object in response to receiving the evaluation trigger by instantiating the eligibility-type object type; instantiating the first criterion object type to generate a first criterion evaluation object, the indication of the criterion evaluation modality in the first criterion field of the first criterion evaluation object indicating a GenAI evaluation modality, the first criterion evaluation object having a link to the eligibility evaluation object; receiving an input associated with a prompt structure in the instruction in the first criterion field of the first criterion evaluation object; constructing a query prompt using the prompt structure based at least in part on the input; providing the constructed query prompt to the GenAI model; receiving a first evaluation result from the GenAI model; and determining an eligibility result of the entity based at least in part on the first evaluation result; wherein at least a part of the method is performed by one or more processors. For example, the method is implemented according to at least FIG. 1, FIG. 2, FIG. 3, FIG. 4, FIG. 5, and/or FIG. 6.

In some embodiments, the input includes a text stream to be input into the prompt structure. In some embodiments, the plurality of criterion object types include a second criterion object type, wherein the second criterion object type includes a first criterion field for an indication of a criterion evaluation modality and a second criterion field for an indication of an instruction; wherein the method further comprises instantiating the second criterion object type to generate a second criterion evaluation object, the second criterion evaluation object having a link to the eligibility evaluation object; wherein the first criterion field of the second criterion evaluation object indicates a function evaluation modality; wherein the second criterion field of the second criterion evaluation object includes a value for a parameter of a function that is used for eligibility evaluation. In some embodiments, the method further comprises: extracting a value associated with the parameter of the function from the input or data associated with the entity; and generating a second evaluation result by applying the function to data associated with the entity; and wherein the eligibility result is determined based at least in part on the second evaluation result. In some embodiments, the extracted value is a numerical value.

In some embodiments, the method further comprises: identifying a software tool associated with the first criterion object type; wherein the constructing a query prompt using the prompt structure based at least in part on the input includes constructing the query prompt based at least in part on the identified software tool; wherein the constructed query prompt includes an indication of the identified software tool. In some embodiments, the plurality of criterion object types are prioritized by a ranking; wherein at least one of the plurality of criterion object types is optional. In some embodiments, the method further comprises: receiving an input associated with the GenAI model; and selecting the GenAI model based on the input associated with the GenAI model. In some embodiments, the method further comprises: identifying a software tool associated with access to data of the entity; wherein the constructing a query prompt using the prompt structure based at least in part on the input includes constructing the query prompt based at least in part on the identified software tool.

According to some embodiments, a system for eligibility evaluation, the system comprising: one or more memories comprising instructions stored thereon; and one or more processors configured to execute the instructions and perform operations comprising: receiving an evaluation trigger associated with an entity; accessing an eligibility-type object type, the eligibility-type object type associating with a plurality of criterion object types, a first criterion object type of the plurality of criterion object types including a first criterion field for an indication of a criterion evaluation modality and a second criterion field for an indication of an instruction; generating an eligibility evaluation object in response to receiving the evaluation trigger by instantiating the eligibility-type object type; instantiating the first criterion object type to generate a first criterion evaluation object, the indication of the criterion evaluation modality in the first criterion field of the first criterion evaluation object indicating a GenAI evaluation modality, the first criterion evaluation object having a link to the eligibility evaluation object; receiving an input associated with a prompt structure in the instruction in the first criterion field of the first criterion evaluation object; constructing a query prompt using the prompt structure based at least in part on the input; providing the constructed query prompt to the GenAI model; receiving a first evaluation result from the GenAI model; and determining an eligibility result of the entity based at least in part on the first evaluation result. For example, the system is implemented according to at least FIG. 1, FIG. 2, FIG. 3, FIG. 4, FIG. 5, and/or FIG. 6.

In some embodiments, the input includes a text stream to be input into the prompt structure. In some embodiments, the plurality of criterion object types include a second criterion object type, wherein the second criterion object type includes a first criterion field for an indication of a criterion evaluation modality and a second criterion field for an indication of an instruction; wherein the operations further comprise instantiating the second criterion object type to generate a second criterion evaluation object, the second criterion evaluation object having a link to the eligibility evaluation object; wherein the first criterion field of the second criterion evaluation object indicates a function evaluation modality; wherein the second criterion field of the second criterion evaluation object includes a value for a parameter of a function that is used for eligibility evaluation. In some embodiments, the operations further comprise: extracting a value associated with the parameter of the function from the input or data associated with the entity; and generating a second evaluation result by applying the function to data associated with the entity; and wherein the eligibility result is determined based at least in part on the second evaluation result. In some embodiments, the extracted value is a numerical value.

In some embodiments, the operations further comprise: identifying a software tool associated with the first criterion object type; wherein the constructing a query prompt using the prompt structure based at least in part on the input includes constructing the query prompt based at least in part on the identified software tool; wherein the constructed query prompt includes an indication of the identified software tool. In some embodiments, the plurality of criterion object types are prioritized by a ranking; wherein at least one of the plurality of criterion object types is optional. In some embodiments, the operations further comprise: receiving an input associated with the GenAI model; and selecting the GenAI model based on the input associated with the GenAI model. In some embodiments, the operations further comprise: identifying a software tool associated with access to data of the entity; wherein the constructing a query prompt using the prompt structure based at least in part on the input includes constructing the query prompt based at least in part on the identified software tool.

For example, some or all components referenced by various embodiments of the present disclosure each are, individually and/or in combination with at least another component, implemented using one or more software components, one or more hardware components, and/or one or more combinations of software and hardware components. In another example, some or all components referenced by various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components referenced by the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for determining eligibility, the method comprising:
receiving an input associated with an eligibility type that is used to determine whether one or more criteria are satisfied;
generating a first criterion object type based at least in part on the input and being associated with at least one of the one or more criteria, the first criterion object type including a first criterion field for an indication of a criterion evaluation modality and a second criterion field for an indication of an instruction, the criterion evaluation modality including at least one selected from a group consisting of a generative artificial intelligence (GenAI) evaluation modality and a function evaluation modality; and
linking the first criterion object type to an eligibility-type object type representing the eligibility type, the eligibility-type object type associating with a plurality of criterion object types including the first criterion object type;
wherein the method is performed by one or more processors.

2. The method of claim 1, wherein the generating a first criterion object type includes:
selecting the first criterion object type from a criterion object type repository; and
updating the first criterion object type based at least in part on the input.

3. The method of claim 1, wherein the plurality of criterion object types include a second criterion object type that is a child criterion type of the first criterion object type.

4. The method of claim 1, wherein the plurality of criterion object types include a second criterion object type that is a parent criterion type of the first criterion object type.

5. The method of claim 1, wherein the indication of the criterion evaluation modality of the first criterion object type is a GenAI evaluation modality; wherein the method further comprises updating the instruction of the second criterion field of the first criterion object type based at least in part on the input; wherein the instruction of the second criterion field of the first criterion object type includes a prompt structure.

6. The method of claim 1, wherein the input includes an indication of a source of policy;
wherein the method further comprises extracting one or more rules from the source of policy;
wherein the generating a first criterion object type based at least in part on the input comprises generating the first criterion object type based at least in part on at least one of the one or more extracted rules.

7. The method of claim 1, wherein the first criterion object type includes a third criterion field for a criterion name.

8. The method of claim 1, wherein the first criterion object type includes a fourth criterion field for an evaluation explanation for a corresponding criterion.

9. The method of claim 1, wherein the plurality of criterion object types are prioritized by a ranking;
wherein at least one of the plurality of criterion object types is optional.

10. A method for eligibility evaluation, the method comprising:
receiving an evaluation trigger associated with an entity;
accessing an eligibility-type object type, the eligibility-type object type associating with a plurality of criterion object types, a first criterion object type of the plurality of criterion object types including a first criterion field for an indication of a criterion evaluation modality and a second criterion field for an indication of an instruction;
generating an eligibility evaluation object in response to receiving the evaluation trigger by instantiating the eligibility-type object type;
instantiating the first criterion object type to generate a first criterion evaluation object, the indication of the criterion evaluation modality in the first criterion field of the first criterion evaluation object indicating a GenAI evaluation modality, the first criterion evaluation object having a link to the eligibility evaluation object;
receiving an input associated with a prompt structure in the instruction in the first criterion field of the first criterion evaluation object;
constructing a query prompt using the prompt structure based at least in part on the input;
providing the constructed query prompt to a GenAI model;
receiving a first evaluation result from the GenAI model; and
determining an eligibility result of the entity based at least in part on the first evaluation result;
wherein at least a part of the method is performed by one or more processors.

11. The method of claim 10, wherein the input includes a text stream to be input into the prompt structure.

12. The method of claim 10, wherein the plurality of criterion object types include a second criterion object type, wherein the second criterion object type includes a first criterion field for an indication of a criterion evaluation modality and a second criterion field for an indication of an instruction;
wherein the method further comprises instantiating the second criterion object type to generate a second criterion evaluation object, the second criterion evaluation object having a link to the eligibility evaluation object;
wherein the first criterion field of the second criterion evaluation object indicates a function evaluation modality;
wherein the second criterion field of the second criterion evaluation object includes a value for a parameter of a function that is used for eligibility evaluation.

13. The method of claim 12, further comprising:
extracting a value associated with the parameter of the function from the input or data associated with the entity; and
generating a second evaluation result by applying the function to data associated with the entity; and
wherein the eligibility result is determined based at least in part on the second evaluation result.

14. The method of claim 13, wherein the extracted value is a numerical value.

15. The method of claim 10, further comprising:
identifying a software tool associated with the first criterion object type;
wherein the constructing a query prompt using the prompt structure based at least in part on the input includes constructing the query prompt based at least in part on the identified software tool;
wherein the constructed query prompt includes an indication of the identified software tool.

16. The method of claim 10, wherein the plurality of criterion object types are prioritized by a ranking;
wherein at least one of the plurality of criterion object types is optional.

17. The method of claim 10, further comprising:
receiving an input associated with the GenAI model; and
selecting the GenAI model based on the input associated with the GenAI model.

18. The method of claim 10, further comprising:
identifying a software tool associated with access to data of the entity;
wherein the constructing a query prompt using the prompt structure based at least in part on the input includes constructing the query prompt based at least in part on the identified software tool.

19. A system for eligibility evaluation, the system comprising:
one or more memories comprising instructions stored thereon; and
one or more processors configured to execute the instructions and perform operations comprising:
receiving an evaluation trigger associated with an entity;
accessing an eligibility-type object type, the eligibility-type object type associating with a plurality of criterion object types, a first criterion object type of the plurality of criterion object types including a first criterion field for an indication of a criterion evaluation modality and a second criterion field for an indication of an instruction;
generating an eligibility evaluation object in response to receiving the evaluation trigger by instantiating the eligibility-type object type;
instantiating the first criterion object type to generate a first criterion evaluation object, the indication of the criterion evaluation modality in the first criterion field of the first criterion evaluation object indicating a GenAI evaluation modality, the first criterion evaluation object having a link to the eligibility evaluation object;
receiving an input associated with a prompt structure in the instruction in the first criterion field of the first criterion evaluation object;
constructing a query prompt using the prompt structure based at least in part on the input;
providing the constructed query prompt to the GenAI model;
receiving a first evaluation result from the GenAI model; and
determining an eligibility result of the entity based at least in part on the first evaluation result.

20. The system of claim 19, wherein the plurality of criterion object types include a second criterion object type, wherein the second criterion object type includes a first criterion field for an indication of a criterion evaluation modality and a second criterion field for an indication of an instruction;
wherein the operations further comprise instantiating the second criterion object type to generate a second criterion evaluation object, the second criterion evaluation object having a link to the eligibility evaluation object;
wherein the first criterion field of the second criterion evaluation object indicates a function evaluation modality;
wherein the second criterion field of the second criterion evaluation object includes a value for a parameter of a function that is used for eligibility evaluation.
